(19) United States
(12) Patent Application Publication
(10) Pub. No.: US 2005/0036916 A1
(43) Pub. Date: Feb. 17, 2005

(54) Sampling device

(75) Inventors: Andrew James Thomas, Wiltshire (GB); Neil Charles Shand, Wiltshire (GB); Andrew John Langdown, Wiltshire (GB)

Correspondence Address: JOHN S. PRATT, ESQ;KILPATRICK STOCKTON, LLP, 1100 PEACHTREE STREET, ATLANTA, GA, 30309, US

(73) Assignee: The Secretary of State for Defence, Salisbury, Wiltshire (GB)

(21) Appl. No.: 10/498,418

(22) PCT Filed: Dec. 12, 2002
(86) PCT No.: PCT/GB02/05640

(30) Foreign Application Priority Data
Dec. 12, 2001 (GB) 0129683.9

(51) Int. Cl. B01L 3/00

(52) U.S. Cl. 422/99

(57) ABSTRACT

A sampling device comprising a foldable support means suitable for supporting a sample collection substrate having at least one sample collection surface, the support means being foldable between a first position in which, in use, the at least one sample collection surface is deployed for the collection of a sample and a second position in which a collected sample is protected against contamination and/or loss.

The present invention relates to sampling devices, in particular, but not exclusively, those that are used to collect material by passing a sample collection surface across a surface that may bear a material of interest.

Sampling of surfaces that may bear a material of interest is often performed by passing a swab of sample collection material across the surface of interest. The swab is usually attached to a suitable support that acts as a handle. The swab is then put into a sealed container to preserve the collected material and to prevent post-sampling contamination of the swab. Such a method is fraught with difficulties; there is a chance that the swab may be dropped on trying to insert the swab into the container. This may render the captured sample useless. Furthermore, the substrate or handle may have to be shortened prior to insertion into the container. The sampling device of the present invention overcomes some of the problems associated with the use of such swabs.

In accordance with the present invention, a sampling device comprising a foldable support means suitable for supporting a sample collection substrate having at least one sample collection surface, the support means being foldable between a first position in which, in use, the at least one sample collection surface is deployed for the collection of a sample and a second position in which a collected sample is protected against contamination and/or loss. Such a sampling device may be used to collect a sample and then protect said sample from subsequent contamination or loss. It should be made clear that the support means may be suitable for supporting more than one sample collection substrate. A hinge arrangement may be used to provide a foldable configuration.

When in the second position, the at least one sample collection surface may be in intimate contact with itself or another part of the sampling device.

In a preferred embodiment, the support means is suitable for supporting two sample collection substrates, each sample collection substrate having a sample collection surface wherein, in use, in the first position both sample collection surfaces are deployed for the collection of a sample and in the second position the sample collection surfaces substantially face each other. This allows two sampling surfaces to be used, and for those surfaces to be brought into co-facial alignment. The support means may be arranged such that, in use, in the second position the sample collection surfaces are in intimate contact with each other over a substantial part of the area of each collection surface. This ensures that the sample is retained in the sampling device and minimises the risk of post-sampling contamination.

In a most preferred embodiment of the sampling device in accordance with the present invention, the support means comprises a handle, the handle comprising two mutually movable handle portions, at least one of the handle portions being suitable for supporting one sample collection substrate, wherein the supported sample collection substrate is orientable between the first and second positions by a folding motion of the two handle portions. This allows hand-held operation of the device. The handle portions may be mutually connected by one or more hinges. Each handle portion may be suitable for supporting a sample collection substrate. The handle portions may be attached to one another in any manner which allows the sample collection surface to be folded between the collection and non-collection positions. The handle portions may be pivotally attached to one another. The handle portions may be mutually connected by frangible connecting means. This prevents re-use of the sampling device; re-use may not be desirable in many circumstances.

It is further preferred that the sampling device comprises at least one sample collection substrate. The substrate may provide a solid matrix for solid-gas phase reactions. Each sample collection substrate preferably comprises glass fibre cloth. It has been found that such material is excellent at collecting certain particulate materials. Furthermore, the glass fibre cloth provides a chemically-inert material that may be inserted into an oven or detection device. The at least one sample collection substrate may be readily removable from the support means. This allows the at least one substrate to be readily inserted into a analytical instrument or the like.

The sampling device may further comprise a means for retaining the support means in the first position, wherein the means for retaining the support means in the first position is disengageable so as to permit the support means to be folded into the second position. Such a means for retaining the support means holds the sampling device in a configuration suitable for collection of sample. The means for retaining the support means in the first position may also urge the sample collection substrate into frictional engagement with the support means. This prevents inadvertent loss of the sample collection substrate.

The sampling device may further comprise means for retaining the support means in the second position. This ensures that the device does not open inadvertently after sampling has taken place. The sampling device may further comprise means for retaining the one or more sample collection substrate in contact with the support means. This is particularly useful if there is a low co-efficient of friction between the support means and the one or more sample collection substrate. The means for retaining the one or more sample collection substrate in contact with the support means is preferably detachable.

The present invention is now described by way of example only with reference to the following figures of which:

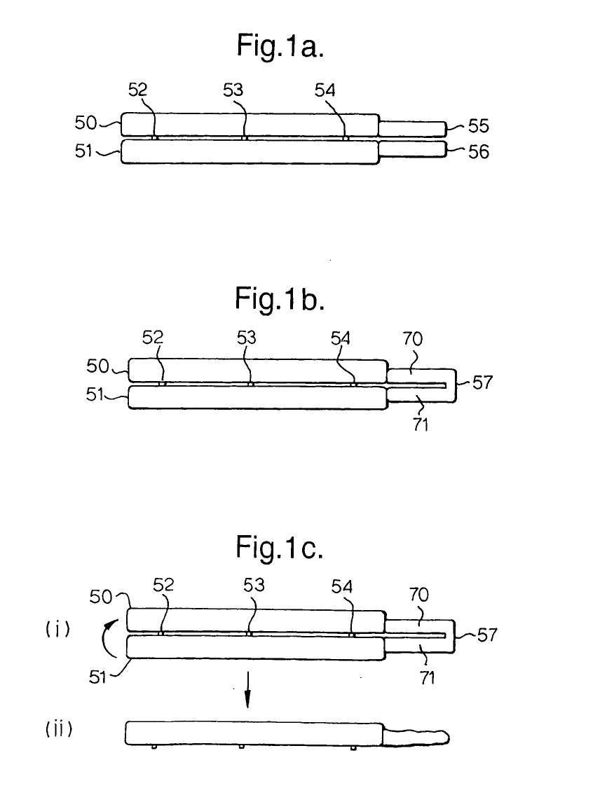

FIG. 1 is a schematic representation of a sampling device in accordance with the present invention;

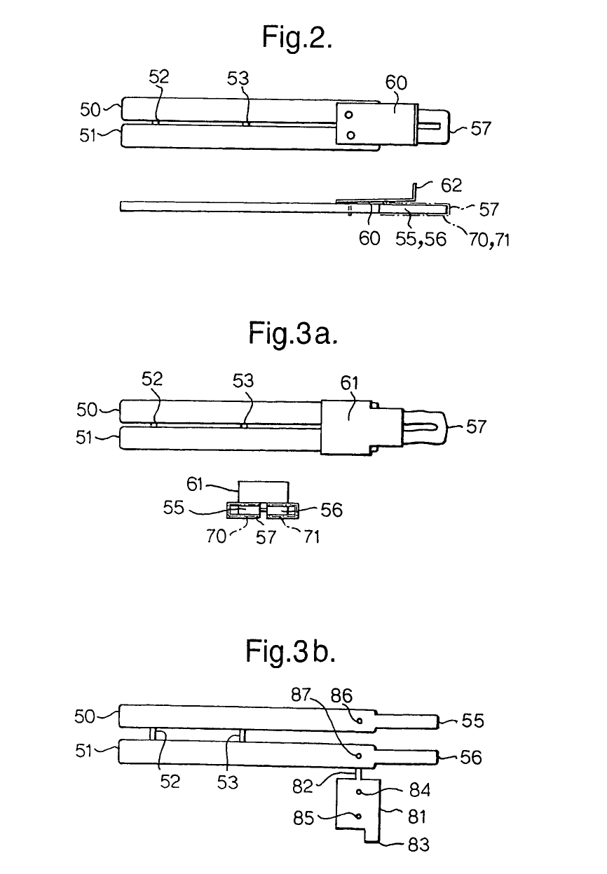

FIG. 2 is a schematic representation of a sampling device in accordance with the present invention comprising a means for retaining the support means in the first, sample collecting position;

FIGS. 3A is a pictorial representation of a sampling device in accordance with the present invention comprising an alternative means for retaining the support means in the first, sample collecting position;

FIGS. 3B is a pictorial representation of a sampling device in accordance with the present invention comprising a further alternative means for retaining the support means in the first, sample collecting position; and

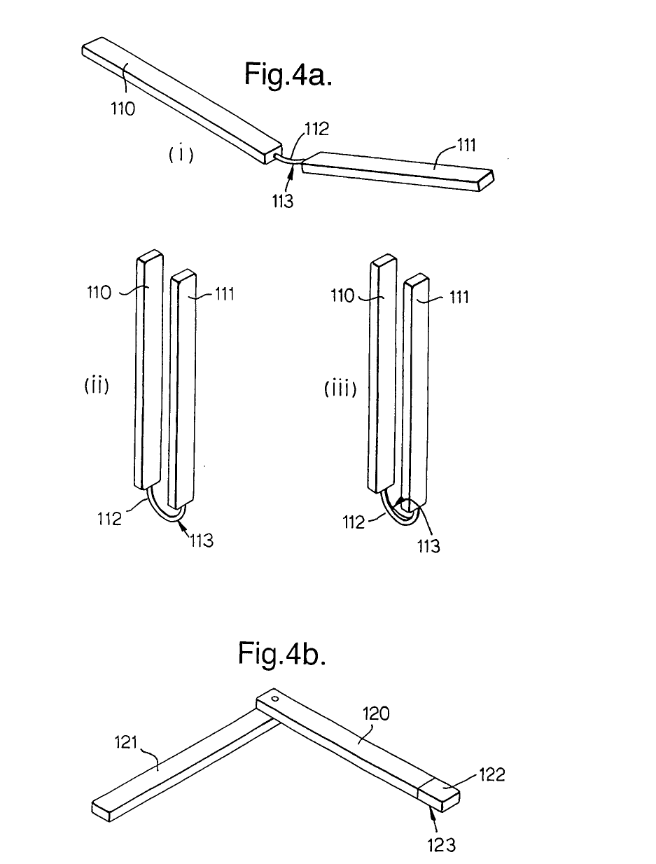

FIG. 4 is a pictorial representation of sampling devices in accordance with the present invention, each device comprising mutually different closure mechanisms.

FIG. 1 shows a schematic of a sampling device in accordance with the present invention. The sampling device comprises handle portions 50, 51, hinges 52, 53, 54, material support fingers 55, 56 and sample collection material 57 having two sample collection surfaces 70, 71. The device essentially comprises two sections, each section comprising a handle portion 50, 51 and a support finger 55, 56. The handle portion 50, 51 and support finger 55, 56 may be mutually discrete and be mutually attached or connected in some known manner. Alternatively, the handle portion 50, 51 and support finger 55, 56 may be made from one piece of material, for example, when the sampling device is made by injection moulding. Each handle portion 50, 51 comprises an elongated substrate attached to the other handle portion 50, 51 by suitably spaced hinges 52, 53, 54. Those skilled in the art will realise that, within the constraints of the relative size of hinges 11d handle portions 50, 51, any number of hinges may be used. Hinges 52, 53, 54 permit folding of the sampling device as shown in FIG. 1c, the advantages of which are discussed below. The sample collection material 57 comprises a woven glass fibre tube, fitted in a U-shaped conformation over the end of support fingers 55, 56. Two smaller tubes may be used, one being placed over each support finger 55, 56. Those skilled in the art will realise that many other materials may be used as a sample collection substrate. The sampling device may be made in one piece by injection moulding. Polypropylene and Acetal Histaform C27021 (Bayer) have been found to be suitable materials for injection moulding. The sampling device is typically 120 mm long and about 15 mm wide, with polymer about 0.5-11.0 mm thick.

The method of operation of the sampling device in accordance with the present invention will now be discussed. The sampling device is opened to the conformation shown in FIGS. 1b and 1c(i) for sampling, the conformation being referred to hereafter as the “open position”. The user holds the device by the handle portions 50, 51 and brings sample collection surfaces 70, 71 into contact with the object having a surface suspected of bearing material of interest. The sample collection surfaces 70, 71 are typically rubbed across the area to be tested in order to pick-up material of interest. Handle portions 50, 51 are then folded together as in FIG. 1c(ii) bringing the sampling device into the conformation referred to hereafter as the “closed position”. This folding action brings sample collection surfaces 70, 71 together, thus any sampled material is held securely therebetween. It is not necessary for the sample collection surfaces 70, 71 to be in mutual contact, merely preferred.

FIG. 2 shows another sampling device in accordance with the present invention. The sampling device comprises handle portions 50, 51, hinges 52, 53, material support fingers 55, 56, sample collection material 57 having two sample collection surfaces 70, 71 and a retention means 60 having a protruding tab 62. The retention means 60 ensures that the device is held in the first (sample collecting) position. Furthermore, the retention means 60 ensures that the sample collection material 57 is held in place during the sample collection. The retention means 60 is a frangible clip which is either pegged or riveted to the handle portions 50, 51. The device generally operates as described above with reference to FIG. 1. However, once the sample has been collected, the user pulls on the tab 62, removing the retention means 60 from the device. The device may then be closed.

FIG. 3A shows another sampling device in accordance with the present invention having an alternative means for retaining the sampling device in the first (sample collecting) position. The sampling device comprises handle portions 50, 51, hinges 52, 53, material support fingers 55, 56, sample collection material 57 having two sample collection surfaces 70, 71 and a retention means 61. The retention means 61 ensures that the sampling device is maintained in the open position for sample collection. Furthermore, the retention means 61 also ensures that the sample collection material 57 is held in place during the sample collection. The retention means 61 is a clip made of a resilient material which resiliently holds the sample collection material 57 against handle portions 50, 51. The device operates substantially as described above with reference to FIG. 1. However, on folding of the handle portions 50, 51 the clip is automatically released and may be removed.

FIG. 3B shows another sampling device in accordance with the present invention having a further alternative means for retaining the sampling device in the first (sample collecting) position. The sampling device comprises handle portions 50, 51, hinges 52, 53, material support fingers 55, 56 and a retention means 81 connected to handle portion 51 by connecting means 82. Support fingers 55, 56 are suitable for the mounting thereon a sample collection material as previously described. The retention means 81 is provided with a peg 85 and a hole 84 for engagement with a hole 86 and a peg 87 respectively provided on handle portions 50, 51. In use, sample collection material (not shown) is provided over material support fingers 55, 56 and retention means 81 is engaged with the handle portions 50, 51 via the hole-peg arrangements described above. This ensures that the support means is held in the first (sample collecting) position. Furthermore, the retention means 81 ensures that the sample collection material is held in place during the sample collection process. Tab 83 enables retention means 81 to be disengaged from the handle portions 50, 51 after collection of the sample. The sampling device of FIG. 3B is injection moulded in one piece from a polymer such as polypropylene.

The retention means 60, 61, 81 of FIGS. 2, 3A and 3B not only maintain the sampling device in an open position, but they also keep the sample collection substrate in place during the sample collection process. The use of such retention means is especially desirable if there is a low coefficient of friction between the sample collection material 57 and the supporting substrate, in this case the support fingers 55, 56.

The sampling device may be further provided with a means for retaining the sampling device in its closed position, ensuring that, post collection, the device remains closed thus reducing the likelihood of sample being lost or contaminated. Referring to FIGS. 1, 2 and 3, a clip (not shown) may be provided across the two handle portions 50, 51 when the sampling device is in the closed position. Alternatively, one of the handles portions 50, 51 may be provided with one or more pegs, each of which mates with a corresponding hole provided in the other handle portion 50, 51 when the handles portions 50, 51 are folded into the closed position. The pegs may be of a resilient material and may be sized and shaped so as to be urged into frictional contact with the walls of the corresponding hole, thus providing a force which resists the opening of the closed device. Each peg may be provided with a lug that protrudes through the corresponding hole when the sampling device is closed. The lug may be shaped so as to resist opening of the device.

The handle portions 50, 51 may be made of the same material as the support fingers 55, 56. This facilitates simple manufacture of the device using a material such as plastic, wherein the handle portions 50, 51, hinges 52, 53, 54 and support fingers 55, 56 may be made from one piece of material. Alternatively, each portion of the device comprising a handle portion 50, 51 and support finger 55, 56 may be made in one piece, the portions being joined together using hinges 52, 53, 54 that are provided separately from the handle portions. However, handle portions 50, 51 may be made of a different material from the support fingers 55, 56. For example, the handle portions 50, 51 may be metal or plastic and the support fingers 55, 56 may be ceramic. Such ceramic fingers 55, 56 may be frangibly attached to the handle portions 50, 51 and may be broken-off and left in an oven or detection device.

Those skilled in the art will realise that the sample collection material 57 may be supplied separately from the rest of the device. This is highly likely if the device is to be used many times prior to disposal. Alternatively, the device may be used only once and then discarded, thus providing an extra safeguard against possible cross-contamination from previous sampling operations. Such a one-shot device may be further enhanced by using frangible hinge attachments between the two handle portions 50, 51. Once the device is closed the hinge attachments would break, thus rendering the device unsuitable for future sample collection. A means for retaining the sampling device in a closed position would be desirable in order to keep the two handle portions 50, 51 together.

For certain one-shot devices (e.g. those used in police forensic work), it is desirable to fit the sample collection material to the support means in a clean environment, such as that provided by a clean room. The complete device could be sealed in a sterile plastic bag, thus providing a clean sampling device for use at a particular site for sample collection.

FIG. 4 shows additional sampling devices in accordance with the present invention, each being arranged in a slightly different manner. In each case the sample collection surfaces are movable between a sample collection position and a non-collection position by the folding action of the handle portions.

FIG. 4a shows a sampling device in accordance with the present invention comprising handle portions 110, 111 connected by a sample collection material 112 having a sample collection surface 113. The handle portions 110, 111 are not attached to each other in any other manner. Sample collection surface 113 may be oriented for sample collection as shown in FIG. 4a(ii). Handle portions 110, 111 may then be oriented such that sample collection surface 113 is folded against itself (FIG. 4a(iii)).

FIG. 4b shows another sampling device in accordance with the present invention comprising handle portions 120, 121 and a sample collection material 122 having a sample collection surface 123. Each handle portion 120, 121 is elongated and has a distal and proximal end. The two handle portions 120, 121 are mutually pivotally attached near to their proximal ends, rather than being connected by a hinge. The sample collection material 122 is located at the distal end of handle portion 120. In use, a folding pivotal motion of the handle portions 120, 121 swings the sample collection material 122 bearing the sample collection surface 123 from a closed position to a sample collection position. Likewise, a folding pivotal motion of handle portions 120, 121 in an opposite direction brings the device to a closed position. A recess (not shown) may be provided at the distal end of handle portion 121 to accommodate the sample collection material 122. An alternative arrangement may involve a pivotal connection being provided between the handle portions 120, 121 that permits relative pivotal motion of the handle portions 120, 121 in a plane orthogonal to the plane of the sample collection surface 123.

Furthermore, the means for supporting the sample collection material need not be a handle and finger arrangement as described above, but could be any suitable support. It is envisaged that the sampling device of the present invention may be operated by remotely controlled vehicles and other machinery, and hence a handle arrangement may not always be suitable.

The sampling device of the present invention may be used with a detection apparatus or analytical instrument, the detection apparatus or analytical instrument being used to examine the material collected by the sampling device. For example, with reference to FIG. 1, the support fingers 55, 56 bearing the sample collection material 57 of the closed sampling device may be inserted into a suitable cavity of a detection apparatus. The sampling device minus the sample collection material 57 may then be removed from the cavity. The sample collection material 57 is left in the detection apparatus ready for testing. Such an insertion method ensures that the sample collection material 57 is subjected to a minimal amount of handling, reducing the likelihood of sample loss and post-sampling contamination. In order to facilitate such a method of insertion, the frictional force exhibited between the sample collection material 57 and the internal sides of the collection apparatus forming the cavity should be greater than that exhibited between the support fingers 55, 56 and the sample collection material 57. If this is not the case, then an appropriate implement such as a pair of tweezers may be used to remove the sample collection material 57 from the support fingers 55, 56.

An alternative method of loading a detection apparatus or the like is for the support fingers 55, 56 to be detachable from the handle portions 50, 51. The support fingers 55, 56 would then remain in the detection apparatus with the sample collection material 57. This is only feasible if the support fingers 55, 56 can withstand the operating conditions in the detection apparatus.

Referring to FIGS. 1-3, the sampling device may be provided with a narrow, tapered portion at the end of the handle portions 50, 51 remote from the support fingers 55, 56. Such a tapered portion is useful for the extraction of a sample collection substrate from a detection apparatus or the like.

1. A sampling device comprising a foldable support means suitable for supporting a sample collection substrate having at least one sample collection surface, the support means being foldable between a first position in which, in use, the at least one sample collection surface is deployed for the collection of a sample and a second position in which a collected sample is protected against contamination and/or loss.

2. A sampling device according to claim 1 wherein, in use, in the second position the at least one collection surface is in intimate contact with itself or another part of the sampling device.

3. A sampling device according to claim 1 wherein the support means is suitable for supporting two sample collection substrates, each sample collection substrate having a sample collection surface wherein, in use, in the first position both sample collection surfaces are deployed for the collection of a sample and in the second position the sample collection surfaces substantially face each other.

4. A sampling device according to claim 3 wherein in the support means is arranged such that, in use, in the second position the sample collection surfaces are in intimate contact with each other for a substantial part of the area of each sample collection surface.

5. A sampling device according claim 1 wherein the support means comprises a handle, the handle comprising two mutually movable handle portions, at least one of the handle portions being suitable for supporting one sample collection substrate, wherein the supported sample collection substrate is orientable between the first and second positions by a folding motion of the two handle portions.

6. A sampling device according to claim 5, wherein the handle portions are mutually connected by one or more hinges.

7. A sampling device according to claim 5 wherein the two handle portions are mutually connected by a frangible connecting means.

8. A sampling device according claim 5 wherein each handle portion is suitable for supporting a sample collection substrate.

9. A sampling device according to claim 1 further comprising at least one sample collection substrate.

10. A sampling device according to claim 9 wherein the at least one sample collection substrate provides a solid matrix for solid-gas phase reactions.

11. A sampling device according claim 9 wherein each sample collection substrate comprises glass fibre cloth.

12. A sampling device according claim 9 wherein the at least one sample collection substrate is readily removable from the support means.

13. A sampling device according claim 1 further comprising a means for retaining the support means in the first position, wherein the means for retaining the support means in the first position is disengageable so as to permit the support means to be oriented into the second position.

14. A sampling device according to claim 1 further comprising means for retaining the support means in the second position.

15. A sampling device according to claim 1 further comprising means for retaining the sample collection substrate in contact with ort means.

16. A sampling device according to claim 15 wherein the means for retaining the sample collection substrate in contact with the support means is detachable.

17. (Cancelled)
